(19) United States
(12) Patent Application Publication
(10) Pub. No.: US 2007/0263892 A1
(43) Pub. Date: Nov. 15, 2007

(54) CELLULAR PHONE POUCH WITH CALLER ID DISPLAY

(75) Inventor: Abraham Glezerman, Tel-Aviv (IL)

Correspondence Address: DARBY & DARBY P.C., P.O. BOX 770, Church Street Station, New York, NY, 10008-0770, US

(73) Assignee: Cardo Corp.

(21) Appl. No.: 11/380,099

(22) Filed: Apr. 25, 2006

(51) Int. Cl. H04R 25/00

(52) U.S. Cl. 381/330

(57) ABSTRACT

A display for use in connection with a call-receiving electronic device, and an associated headset electronic device, wherein the display is in wireless communication with and physically independent of the call-receiving electronic device and headset. The display is preferably supported by a holster, wherein the holster is further sized to seat the headset while the headset is not in use. The call-receiving electronic device is capable of wirelessly communicating at least caller ID information to a first communication module associated with the headset or to a second communication module associated with the display. Optionally, the first module wirelessly communicates at least the caller ID information to the second communication module associated with the display. The second module outputs at least the caller ID information to the display. Thus, a user can view the caller ID information on the display without having to handle the call-receiving electronic device or the headset.

### BACKGROUND OF THE INVENTION

1. Field of the Invention

The present invention relates to caller identification devices for use with call-receiving electronic devices and, more particularly, to a caller identification device which is independent of, yet in communication with, a headset that is associated with a call-receiving electronic device.

2. Discussion of the Related Art

Displays that display caller identification (“caller ID”) information are known in the art and have been of various types, including displays integral to headsets, displays integral to cellular phones, and displays specifically configured for use with motor vehicles.

Often electronic call-receiving devices, such as cellular telephones, are used in conjunction with an associated headset device. The headset is typically supported by the ear of the user and includes a speaker and microphone. The use of the headset provides the convenience of hands free talking while using a cellular phone. However the convenience of the hands free environment that a headset helps create is limited by the need to locate and handle the cellular phone or headset to determine a caller's identity.

U.S. Patent Publication No. 2004/0137967 of Bodley discloses a wireless headset with an integral display. The headset can be associated with a cellular phone, and when used in conjunction, the headset and cellular phone facilitate communication with callers. The headset includes a clip for supporting the headset from the user's ear. Supporting the headset from the ear is intended to create a hands free communication environment. The display, which is integral to the headset, can display various information, including caller ID information, battery levels, and current time.

U.S. Patent Publication No. 2003/0092384 of Ross III discloses a radio telephone interface for vehicles that includes a pointing device that is coupled to the vehicle steering mechanism, and a display. The display is coupled to the windshield of the vehicle and provides a heads-up display. Caller ID information and a telephone touch pad can be displayed on the vehicle windshield. The pointing device can be used to control a pointer which also appears on the display. The pointing device can be used to select images on the display, which in turn sends signals that operate the radio telephone. In addition, the heads-up display can be displayed on the windscreen of a motorcycle or the windscreen of a motorcycle helmet.

The headsets and displays as described above have limitations that impede viewing information such as caller ID information. For example, integrated displays render the headset bulkier and heavier than otherwise achievable, while separating the two allows for lighter devices with a smaller footprint. Also, displays that are integral with the headset require the removal of the headset from the ear in order view information displayed. These devices require the headsets to be handled and oriented to view the display, which is an inconvenience when the headset is supported on the side of the head. Also, vehicle based displays are required to be used in connection with a vehicle. These systems limit the portability and versatility of cellular telephones and headsets. Vehicle based displays are limited to use in the vehicular environment.

It would be desirable to have a display independent of a cellular phone or headset that could display various information, including caller ID information and, further, it would be desirable to have such a display associated with a pouch or holder for a headset, phone, or both. The present invention satisfies these and other needs.

### SUMMARY OF THE INVENTION

The present invention is directed to a device that is physically independent of a call-receiving electronic device and an associated headset, the device permitting various information, including caller ID information, to be displayed.

In accordance with a first aspect of the invention, a caller identification device is provided for use in conjunction with a call-receiving electronic device. The caller identification device has a headset including a first module that communicates wirelessly with the electronic device and a speaker electrically connected to the first module. A holster is sized to seat the headset and supports the second module, which is in wireless communication at least the first module. A display is also supported by the holster and electrically connected to the second module so as to output any caller identification information received by one of the first and second modules.

In accordance with a more particular aspect of the invention, the call-receiving electronic device communicates with the headset via the first module and the display outputs the caller identification based on communication with the second module. By using separate first and second modules, different communication standards can be supported for communications to and from each respective module. For example, the second module optionally supports one-way communication of caller identification information and any other information from the first module to the second module.

In accordance with another aspect of the present invention, a caller identification device useful in conjunction with a call-receiving electronic device includes a headset having a first communication module which is configured for wireless communication with the electronic device so as to receive at least caller identification information; a display which is independent of the headset and the electronic device; and a second communication module which is connected to receive at least the caller identification information from the first communication module and to communicate the caller identification information to the display. More particular arrangements in accordance with this aspect of the invention can be as described above.

In accordance with a still further aspect of the invention, a caller identification device useful in conjunction with a call-receiving electronic device and an associated headset is provided. Such a caller identification device includes a holster sized to seat the headset; a module which is supported by the holster and which is in wireless communication with the headset, the electronic device, or both so as to receive at least caller identification information; and a display, also supported by the holster, connected to receive at least the caller identification information from the module and to output the caller identification information independent of the electronic device or the headset. In accordance with this aspect of the invention, caller identification information can be seen at the output of the display either when the headset is in use or when it is stowed in or on the holster. More particular arrangements in accordance with this aspect of the invention can be as described above.

These and other aspects, features and advantages of the invention are apparent from the following description of certain illustrative embodiments and the accompanying drawing figures.

### BRIEF DESCRIPTION OF THE DRAWINGS

FIG. 1 is a view of a holster, a call receiving electronic device, and a headset arranged on a user;

FIG. 2 is a top view of the holster of FIG. 1 with a display in accordance with a preferred embodiment of the invention;

FIG. 3 is a side view of the holster of FIG. 1;

FIG. 4 is a front view of the holster of FIG. 1 showing a headset seated therein; and

FIG. 5 is a front view of the headset.

### DESCRIPTION OF ILLUSTRATIVE EXEMPLARY EMBODIMENTS

FIG. 4 illustrates one exemplary embodiment, wherein a holster 11, a cellular telephone 12 and a headset 13 are in wireless communication. The cellular telephone 12 is configured to send and receive calls from a standard external wireless network, such as a cellular network. Cellular telephone 12 represents one type of call-receiving electronic device, but it can also be substituted for any electronic device having call-receiving and/or call-initiating capabilities, such as a personal digital assistant, pocket personal computer, or media player. In addition, the cellular telephone 12 is also configured for wireless communication with local devices, such as headset 13, preferably using the Bluetooth® protocol.

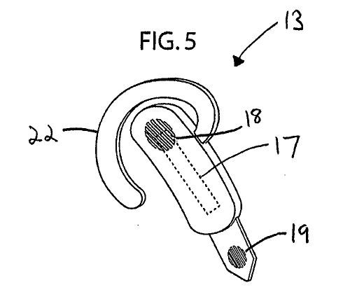

The headset 13 is supportable near the ear of the user and can have a variety of shapes and configurations. As shown in FIG. 5, hook 22 is provided on headset 13 for supporting the headset from the ear of the user. Other means of supporting headset 13 near the ear of the user are available, including supporting the headset from the frame of a pair of eye glasses as disclosed in U.S. patent application Ser. No. 10/605,667 of Glezerman, filed Oct. 16, 2003, the entirety of which is hereby incorporated by reference. Note that, the hook 22 can be removably connected to the headset 13 and exchanged for other attachments as described in the '667 application.

The headset 13 includes a communication module 17, a speaker 18, and a microphone 19, which are electrically connected to each other. The headset 13 receives and transduces sound from a user's spoken voice at the microphone 19 and outputs sound from another conversant's spoken voice at speaker 18. The audio signals containing the voice information are transmitted in two-way communication between the headset 13 and the cellular phone 12 by communication module 17, which communicates in a protocol compliant with that of the cellular telephone 12, and which is preferably the Bluetooth® protocol.

Communication module 17 is further configured to receive other information, including caller ID information, transmitted from cellular phone 12 to headset 13. Such information is typically transmitted and available to the communication module 17, as understood by those of skill in the art.

The communication module 17 preferably enables communication between the headset 13 and the holster 11. Communication between the headset 13 and holster 11 is described below.

The holster 11 is sized to seat the headset 13, as illustrated in FIG. 4. The holster 11 preferably includes a cover 20 and a base 21. The headset 13 is seated within base portion 21 of the holster 11. Cover 20 in this embodiment can be selectively opened and closed in order to insert and remove headset 13. Alternatively, the holster 11 can be featured with hooks, clips, slots, or other suitable means for enabling the headset 13 to be affixed to or seated in the holster 11.

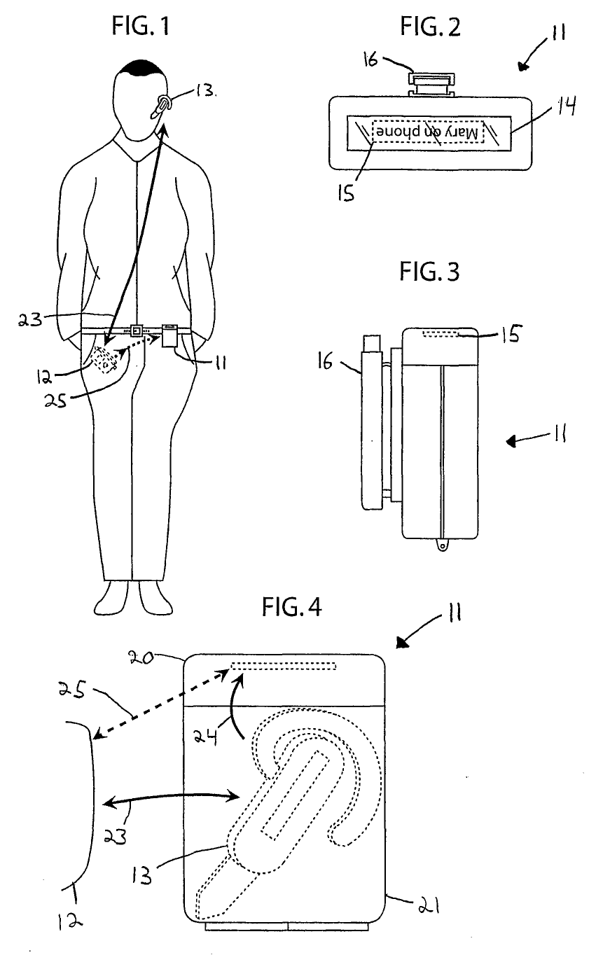

A clip 16 is preferably connected to a rear surface of the holster 11, as shown in FIG. 3. The clip 16 allows the holster 11 to be connected to and supported by a user's belt, as shown in FIG. 1. Clip 16 can be of various types and configurations to allow the holster 11 to be supported at a variety of sites including the edge of a garment pocket, on the strap of a bag, on the visor of a vehicle, or any other convenient or suitable site.

The holster 11 includes a communication module 15 and a display 14, as shown in FIG. 2. The communication module 15 (shown in dashed lines) enables wireless communication with other devices, such as headset 13 or cellular phone 12. The display 14, which is preferably located on the top surface of the holster 11, is a conventional display screen comprising, for example, an LCD, LED, or EL element. The communication module 15 and the display 14 are electrically connected so that information received by module 15 can be output to the display 14. The display 14 is capable of displaying various information, including caller ID information, which can be used to identify the source of an incoming call being received by the cellular phone 12, or the time.

As shown in FIG. 4, the cellular phone 12 is in wireless communication with communication module 17 of the headset 13 (represented by arrowed line 23), which is in turn in wireless communication with communication module 15 (represented by arrowed line 24). This permits information regarding the status of the cellular phone 12, such as caller ID information or the time to be displayed on display 14.

When, for example, a call is being received by cellular phone 12, the caller ID information is transmitted to module 17 of the headset 13. Headset communication module 17 in turn transmits the caller ID information to communication module 15 of the holster 11, which receives the caller ID information and provides the information to the display 14. The user can then simply view display 14 to determine the identity of the caller. As a result, the user can determine the identity of the caller and decide whether or not to answer the call all without handling the headset 13 or the cellular phone 12. Thus, the user is spared the inconvenience of having to examine the cellular phone or remove the headset from the holder 11 for a call that the user may not want to accept.

If, after viewing the display 14 and deciding to accept the call, the user can accept the call in the standard manner. Once the user and the other conversant are connected, the user can simply communicate with the other conversant using the speaker 18 and microphone 19 of headset 13. The headset communication module 17 can transmit and receive the conversation voice information to and from the cellular phone 12. In addition, other information can be relayed from the cellular phone 12 to the display 14 via communication modules 15 and 17 while the call is in progress. This additional information can include the duration of the call, signal strength, battery strength, the time, date, the caller ID information of yet another caller, or other information. This additional information can also be communicated and displayed when there is no call in progress.

The wireless communication between cellular phone 12 and communication module 17 of the headset is preferably accomplished using standard methods of wireless communication, preferably using the Bluetooth® protocol. The communication module 17 is preferably configured for additional wireless communication using other methods such as Bluetooth®, infrared signals or dual tone multi-frequency (“DTMF”) signals. Communication module 15 associated with the holster is preferably configured to receive Bluetooth®, infrared or DTMF signals, but can be configured to receive more than one type of signal.

Thus, communication module 17 of the headset is capable of communicating with communication module 15 of the holster using Bluetooth®, infrared and/or DTFM signals, as shown by arrowed line 24 in FIG. 4. The caller ID information is transmitted to communication module 15 using the Bluetooth®, infrared and/or DTMF signals and outputted to the display 14. Communication module 17 can be configured to directly output the Bluetooth®, infrared and/or DTMF signals. Outputting the DTMF signals can also be accomplished using speaker 18 of the headset.

Communication module 15 can optionally be configured to communicate using the same wireless protocol that is used for communication between cellular telephone 12 and communication module 17, which is preferably the Bluetooth® protocol. Providing communication module 15 with Bluetooth® capability enables communication with communication module 17 of the headset and direct communication with cellular telephone 12, as shown by dashed line 25 in FIGS. 1 and 4. Bluetooth® communication between modules 15 and 17 increases the range that the modules can be operated as compared to the ranges capable when using infrared or DTMF. Communication module 15 can be configured with various combinations of DTMF, infrared, or Bluetooth™ capabilities, including all three together.

Providing Bluetooth® capability to the communication module 15 permits direct communication with Bluetooth® enabled cellular phones or headsets without requiring a headset to have infrared, DTMF or other secondary communication circuitry. Holster 11 can be sized to seat these headsets and/or cellular phones. Thus, for example, a user can use various cellular phones and headsets, and have the convenience of having holster 11 to stow the headset and have the display 14 display caller ID information.

While the invention has been particularly shown and described with reference to preferred embodiments thereof, it will be understood by those skilled in the art that various changes in form and details may be made therein without departing from the spirit and scope of the invention.

I claim:

1. A caller identification device for use with a call-receiving electronic device, comprising:
a headset including a first module in wireless communication with the electronic device so as to receive at least caller identification information and a speaker electrically connected to the first module;
a holster sized to seat the headset;
a second module supported by the holster and in wireless communication with the first module; and
a display supported by the holster and electrically connected to the second module so as to output the caller identification information.

2. The device of claim 1, wherein the electronic device is a cellular telephone and the display displays the caller identification information.

3. The device of claim 1, wherein the second module provides one-way communication from the first module to the second module.

4. The device of claim 1, wherein the speaker generates DTMF signals based upon the caller identification information received at the first module, and wherein the second module is configured to receive the DTMF signals as the wireless communication from the first module.

5. The device of claim 1, wherein the first module generates infrared signals based upon the caller identification information received at the first module, and wherein the second module is configured to receive the infrared signals as the wireless communication from the first module.

6. The device of claim 1, wherein the display displays a current time in addition to the caller identification information.

7. A caller identification device for use with a call-receiving electronic device, comprising:
a headset including a first communication module configured for wireless communication with the electronic device so as to receive at least caller identification information;
a display independent of the headset and the electronic device; and
a second communication module connected to receive at least the caller identification information from the first communication module and to communicate the caller identification information to the display.

8. The device of claim 7, wherein the electronic device is a cellular telephone and the display displays the caller identification information.

9. The device of claim 7, wherein the second module provides one-way communication from the first module to the second module.

10. The device of claim 7, wherein the first module generates DTMF signals based upon the caller identification information received at the first module, and wherein the second module is configured to receive the DTMF signals as the wireless communication from the first module.

11. The device of claim 7, wherein the first module generates infrared signals based upon the caller identification information received at the first module, and wherein the second module is configured to receive the infrared signals as the wireless communication from the first module.

12. The device of claim 7, wherein the display displays a current time in addition to the caller identification information.

13. A caller identification device for use with a call-receiving electronic device and an associated headset, comprising:
a holster sized to seat the headset;
a module supported by the holster and in wireless communication with at least one of the headset and the electronic device so as to receive at least caller identification information; and
a display supported by the holster and connected to receive at least the caller identification information from the module and to output the caller identification information independent of the electronic device and the headset.

14. The device of claim 13, wherein the electronic device is a cellular telephone and the display displays the caller identification information.

15. The device of claim 13, wherein the module provides one-way communication from at least one of the headset and the electronic device to the module.

16. The device of claim 13, wherein at least one of the headset and the electronic device generates DTMF signals based upon the caller identification information, and wherein the module is configured to receive the DTMF signals as the wireless communication.

17. The device of claim 13, wherein at the wireless communication between the module and at least one of the headset and the electronic device is in accordance with the Bluetooth® protocol.

18. The device of claim 13, wherein at least one of the headset and the electronic device generates infrared signals based upon the caller identification information, and wherein the module is configured to receive the infrared signals as the wireless communication.

19. The device of claim 13, wherein the display displays a current time in addition to the caller identification information.
